(19) United States
(12) Patent Application Publication
(10) Pub. No.: US 2023/0395944 A1
(43) Pub. Date: Dec. 7, 2023

(54) AIR ELECTRODE/SEPARATOR ASSEMBLY AND METAL-AIR SECONDARY BATTERY

(71) Applicant: NGK INSULATORS, LTD., Nagoya-City (JP)

(72) Inventors: Yukari SAKURAYAMA, Nagoya-City (JP); Naomi HASHIMOTO, Nagoya-City (JP); Ozora KANO, Nagoya-City (JP); Naomi SAITO, Nagoya-City (JP)

(73) Assignee: NGK INSULATORS, LTD., Nagoya-City (JP)

(21) Appl. No.: 18/449,003

(22) Filed: Aug. 14, 2023

Related U.S. Application Data
(63) Continuation of application No. PCT/JP2021/044333, filed on Dec. 2, 2021.

(30) Foreign Application Priority Data
Mar. 30, 2021 (JP) 2021-058884

(51) Int. Cl. H01M 50/497; H01M 12/08; H01M 50/451

(52) U.S. Cl. CPC H01M 50/497; H01M 12/08; H01M 50/451

(57) ABSTRACT

Provided is an air electrode/separator assembly including a hydroxide ion conductive separator including an inner space, a pair of catalyst layers covering both surfaces of the hydroxide ion conductive separator and containing a catalyst for an air electrode, a hydroxide ion conductive material, and an electron conductive material, a pair of gas diffusion electrodes provided on the pair of catalyst layers on a side opposite to the hydroxide ion conductive separator, and a water absorption/desorption layer provided so as to contact both of the pair of catalyst layers, having water absorbability and desorbability. One of the pair of catalyst layers is a catalyst layer for discharge and the other of the pair of catalyst layers is a catalyst layer for charge; and the hydroxide ion conductive separator, the catalyst layer, and the gas diffusion electrode are arranged vertically, and the water absorption/desorption layer is positioned below the catalyst layer.

### CROSS-REFERENCE TO RELATED APPLICATIONS

This application is a continuation application of PCT/JP2021/044333 filed Dec. 2, 2021, which claims priority to Japanese Patent Application No. 2021-058884 filed March 2021, the entire contents all of which are incorporated herein by reference.

### BACKGROUND OF THE INVENTION

### 1. Field of the Invention

The present disclosure relates to an air electrode/separator assembly and metal-air secondary battery.

### 2. Description of the Related Art

One of the innovative battery candidates is a metal-air secondary battery. In the metal-air secondary battery, oxygen as a positive electrode active material is supplied from the air, and the space inside the battery container can thus be utilized to the maximum extent for filling the negative electrode active material, whereby in principle a high energy density is realized. For example, in a zinc-air secondary battery, in which zinc is used as a negative electrode active material, an alkaline aqueous solution such as potassium hydroxide is used as an electrolyte, and a separator (partition membrane) is used to prevent a short circuit between positive and negative electrodes. Upon discharge, O₂ is reduced on an air electrode (positive electrode) side to generate OH⁻, while zinc is oxidized on a negative electrode to generate ZnO, as shown in the following reaction formulas.

Positive electrode: O₂+2H₂O+4e⁻→4OH⁻

Negative electrode: 2Zn+4OH⁻→2ZnO+2H₂O+4e⁻

By the way, it is known that in zinc secondary batteries such as a zinc-air secondary battery and nickel-zinc secondary battery, metallic zinc in a dendrite form precipitates from a negative electrode upon charge, penetrates voids of a separator such as a nonwoven fabric, and reaches a positive electrode, resulting in occurrence of a short circuit. This short circuit due to such zinc dendrites leads to shorten repeated charge/discharge life. Moreover, another problem with the zinc-air secondary battery is that carbon dioxide in the air passes through the air electrode, dissolves in the electrolyte, and precipitates an alkali carbonate to deteriorate the battery performance. Similar problems as described above can occur with lithium-air secondary batteries.

In order to deal with the problems described above, a battery comprising a layered double hydroxide (LDH) separator that blocks the penetration of zinc dendrite while selectively permeating hydroxide ions has been proposed. For example, Patent Literature 1 (WO2013/073292) discloses a zinc-air secondary battery including a LDH separator provided between an air electrode and a negative electrode in order to prevent both the short circuit between the positive and negative electrodes due to zinc dendrite and the inclusion of carbon dioxide. Patent Literature 2 (WO2016/076047) discloses a separator structure comprising an LDH separator fitted or joined to a resin outer frame, wherein the LDH separator has a high denseness such that it has a gas impermeability and/or water impermeability. Moreover, the literature also discloses that the LDH separator can be composited with a porous substrate. Further, Patent Literature 3 (WO2016/067884) discloses various methods for forming an LDH dense membrane on a surface of a porous substrate to obtain a composite material (LDH separator). This method comprises steps of uniformly adhering a starting material that can impart a starting point for LDH crystal growth to the porous substrate, treating hydrothermally the porous substrate in a raw material aqueous solution to form an LDH dense membrane on a surface of the porous substrate. Moreover, LDH-like compounds have being known as hydroxides and/or oxides with a layered crystal structure that cannot be called LDH but are analogous thereto, which exhibit hydroxide ion conductive properties similar to those of LDH to an extent that it can be collectively referred to as hydroxide ion conductive layered compounds together with LDH. For example, Patent Literature (WO2020/255856) discloses a hydroxide ion conductive separator containing a porous substrate and a layered double hydroxide (LDH)-like compound that clogs up pores in the porous substrate.

Moreover, in a field of metal-air secondary batteries such as a zinc-air secondary battery, an air electrode/separator assembly in which an air electrode layer is provided on an LDH separator has been proposed. Patent Literature 5 (WO2015/146671) discloses an air electrode/separator assembly comprising an LDH separator and an air electrode layer thereon, the air electrode layer containing an air electrode catalyst, an electron conductive material, and a hydroxide ion conductive material. Further, Patent Literature 6 (WO2018/163353) discloses a method for producing an air electrode/separator assembly by directly joining an air electrode layer containing LDH and carbon nanotubes (CNT) on an LDH separator. Furthermore, Patent Literature 7 (WO2020/246176) discloses an air electrode/separator assembly comprising a hydroxide ion conductive separator, an interface layer including a hydroxide ion conductive material and an electron conductive material and covering one side of this separator, and an air electrode layer provided on the interface layer and containing an outermost catalyst layer composed of a porous current collector and a layered double hydroxide (LDH) covering a surface thereof.

### CITATION LIST

### Patent Literature

Patent Literature 1: WO2013/073292
Patent Literature 2: WO2016/076047
Patent Literature 3: WO2016/067884
Patent Literature 4: WO2020/255856
Patent Literature 5: WO2015/146671
Patent Literature 6: WO2018/163353
Patent Literature 7: WO2020/246176

### SUMMARY OF THE INVENTION

As described above, the metal-air secondary battery including an LDH separator has an excellent advantage of preventing both a short circuit between the positive and negative electrodes due to the metal dendrite and an inclusion of carbon dioxide. Further, it also has an advantage of being capable of inhibiting evaporation of water contained in the electrolyte due to the denseness of the LDH separator. However, since the LDH separator blocks the permeation of the electrolyte into the air electrode, the electrolyte is absent in the air electrode layer. Therefore, water consumed or generated in the air electrode is impossible to circulate, compared with a zinc-air secondary battery including a general separator (for example, a porous polymer separator) that allows permeation of an electrolyte into an air electrode, leading to a decrease in charge/discharge performance. Therefore, there is a need for water absorption/desorption system that exhibits excellent charge/discharge performance while having advantages of using an LDH separator.

The present inventors have now found that a battery when used as a metal-air secondary battery exhibits excellent charge/discharge performance by providing a water absorption/desorption layer so as to contact both a positive electrode for discharge and a positive electrode for charge below the positive electrode for discharge and the positive electrode for charge, which interpose a metal negative electrode housed in a hydroxide ion conductive separator such as an LDH separator in a battery case. The present inventors have also found that it is possible to provide an air electrode/separator assembly suitable for providing a metal-air secondary battery including such a water absorption/desorption layer.

Therefore, an object of the present invention is to provide an air electrode/separator assembly that exhibits excellent charge/discharge performance when used in a metal-air secondary battery while including a hydroxide ion conduction separator such as an LDH separator.

The present invention provides the following aspects.

[Aspect 1] An air electrode/separator assembly, comprising:
a hydroxide ion conductive separator comprising an inner space capable of housing a metal negative electrode, or a metal negative electrode and an electrolyte-containing nonwoven fabric,
a pair of catalyst layers covering both surfaces of the hydroxide ion conductive separator and comprising a catalyst for an air electrode, a hydroxide ion conductive material, and an electron conductive material,
a pair of gas diffusion electrodes provided on the pair of catalyst layers on a side opposite to the hydroxide ion conductive separator, and
a water absorption/desorption layer provided so as to contact both of the pair of catalyst layers, having water absorbability and desorbability,
wherein one of the pair of catalyst layers is a catalyst layer for discharge and the other of the pair of catalyst layers is a catalyst layer for charge, and
wherein the hydroxide ion conductive separator, the catalyst layer, and the gas diffusion electrode are arranged vertically and the water absorption/desorption layer is positioned below the catalyst layer.

[Aspect 2] The air electrode/separator assembly according to Aspect 1, wherein the water absorption/desorption layer comprises a water absorbent resin.

[Aspect 3] The air electrode/separator assembly according to Aspect 2, wherein the water absorption/desorption layer further comprises silica gel.

[Aspect 4] The air electrode/separator assembly according to Aspect 2 or 3, wherein the water absorbent resin is at least one selected from the group consisting of a polyacrylamide-based resin, potassium polyacrylate, a polyvinyl alcohol-based resin, and a cellulose-based resin.

[Aspect 5] The air electrode/separator assembly according to any one of Aspects 2 to 4, wherein the catalyst layer comprises 0.01 to 10% by volume of the water absorbent resin in terms of solid content relative to 100% by volume of solid content of the catalyst layer.

[Aspect 6] The air electrode/separator assembly according to any one of Aspects 1 to 5, wherein the hydroxide ion conductive material included in the catalyst layer is a layered double hydroxide (LDH).

[Aspect 7] The air electrode/separator assembly according to any one of Aspects 1 to 6, wherein the catalyst layer comprises 20 to 50% by volume of the hydroxide ion conductive material relative to 100% by volume of solid content of the catalyst layer.

[Aspect 8] The air electrode/separator assembly according to any one of Aspects 1 to 7, wherein the hydroxide ion conductive separator is a layered double hydroxide (LDH) separator.

[Aspect 9] The air electrode/separator assembly according to Aspect 8, wherein the LDH separator is composited with a porous substrate.

[Aspect 10] The air electrode/separator assembly according to any one of Aspects 1 to 9, wherein the hydroxide ion conductive separator comprising the inner space comprises a pair of hydroxide ion conductive separators facing each other or a folded hydroxide ion conductive separator, and the pair of hydroxide ion conductive separators or the folded hydroxide ion conductive separator may have sides (excluding folded edges) other than the top edges closed with each other by joining.

[Aspect 11] A metal-air secondary battery comprising the air electrode/separator assembly according to any one of Aspects 1 to 10, a metal negative electrode housed in the inner space, and an electrolyte, wherein the water absorption/desorption layer is positioned below the catalyst layer.

[Aspect 12] The metal-air secondary battery according to Aspect 11, further comprising an electrolyte-containing nonwoven fabric in the inner space.

### BRIEF DESCRIPTION OF THE DRAWINGS

FIG. 1 is a schematic cross-sectional view conceptually illustrating an example of a metal-air secondary battery including the air electrode/separator assembly of the present invention.

FIG. 2 is a view illustrating a layer configuration of a side including a catalyst layer for discharge, of the air electrode/separator assembly shown in FIG. 1.

FIG. 3 is a view illustrating a layer configuration of a side including a catalyst layer for charge, of the air electrode/separator assembly shown in FIG. 1.

FIG. 4 is a schematic cross-sectional view conceptually illustrating an LDH separator used in the present invention.

FIG. 5A is a conceptual view of an example of the He permeability measurement system used in Example A1.

FIG. 5B is a schematic cross-sectional view of a sample holder used in the measurement system shown in FIG. 5A and peripheral configuration thereof.

FIG. 6 is an SEM image when observing a surface of the LDH separator fabricated in Example A1.

FIG. 7A is an SEM image when observing a surface of carbon fibers constituting carbon paper in the catalyst layer fabricated in Example B1.

FIG. 7B is an enlarged SEM image when observing a surface of the carbon fiber shown in FIG. 7A.

FIG. 7C is an SEM image when observing a cross section in a vicinity of a surface of the carbon fiber shown in FIG. 7A.

FIG. 8 is an exploded perspective view of the evaluation cell fabricated in Example B1.

FIG. 9 is a schematic cross-sectional view of the evaluation cell fabricated in Example B1.

FIG. 10 is a graph illustrating charge/discharge cycle characteristics measured for the evaluation cells fabricated in Examples B1 and B2.

### DETAILED DESCRIPTION OF THE INVENTION

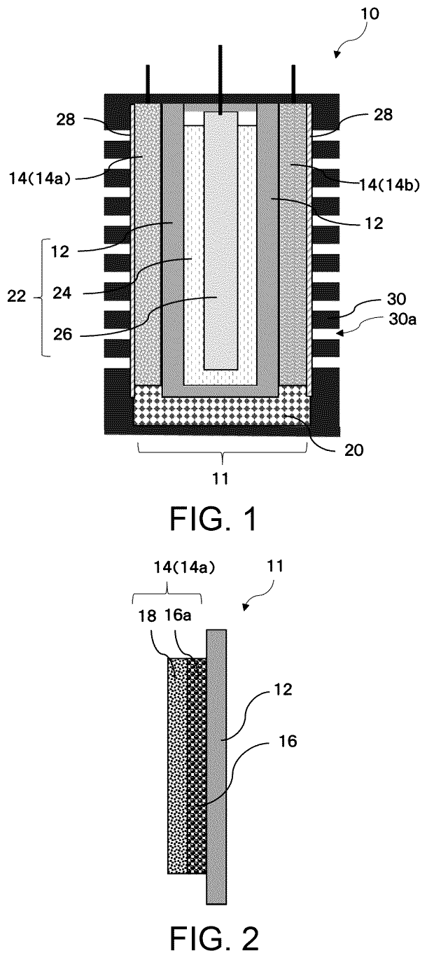

FIG. 1 conceptually shows an example of a metal-air secondary battery including the air electrode/separator assembly of the present invention. Metal-air secondary battery 10 shown in FIG. 1 is equipped with a negative electrode layer 22, a positive electrode 14a for discharge (air electrode layer for discharge), a positive electrode 14b for charge (air electrode layer for charge), and a water absorption/desorption layer 20, in a battery case 30 including a substrate with gas channels having vent holes 30a. Negative electrode layer 22 includes an LDH separator 12 and a metal negative electrode 26 that is housed (together with an electrolyte-containing nonwoven fabric 24) in an inner space of LDH separator 12. Metal negative electrode 26 includes a metal that serves as a negative electrode active material. Positive electrode 14a for discharge is an air electrode layer used as a positive electrode upon discharge. Positive electrode 14b for charge is an air electrode layer used as a positive electrode upon charge. Water absorption/desorption layer 20 is provided so as to contact positive electrode 14a for discharge and positive electrode 14b for charge. A water repellent layer 28 is provided on an outside of the battery structure thus configured, and is fixed with screws at eight locations at the end of battery case 30. According to such a configuration, there are provided negative electrode layer 22 including metal negative electrode 26 and electrolyte-containing nonwoven fabric 24 and housed in LDH separator 12, positive electrode 14a for discharge arranged on one side of metal negative electrode 26, positive electrode 14b for charge arranged on the other side of metal negative electrode 26, water absorption/desorption layer 20 composed of an acrylamide-based water absorbent polymer material or the like so as to contact both positive electrode 14a for discharge and positive electrode 14b for charge, and a space for installing water absorption/desorption layer 20.

In FIG. 1, the configuration including LDH separator 12, a pair of air electrode layers 14 (positive electrode 14a for discharge and positive electrode 14b for charge) covering both surfaces of LDH separator 12, and water absorption/desorption layer 20 (excluding metal negative electrode 26 and nonwoven fabric 24), corresponds to an air electrode/separator assembly 11. As also shown in FIGS. 2 and 3, air electrode/separator assembly 11 has a configuration in which a catalyst layer 16a for discharge and a gas diffusion electrode 18 are laminated in order on one side of LDH separator 12 to form positive electrode 14a for discharge, and a configuration in which a catalyst layer 16b for charge and gas diffusion electrode 18 are laminated in order on the other side of LDH separator 12 to form positive electrode 14b for charge. Therefore, using air electrode/separator assembly 11 and combination of metal negative electrode 26, nonwoven fabric 24 (if necessary), and an electrolyte, conveniently enables configuration of metal-air secondary battery 10.

Metal-air secondary battery 10 illustrated in FIG. 1 is a three-electrode system secondary battery in which metal negative electrode 26 housed together with an electrolyte in an inner space of LDH separator 12, positive electrode 14a for discharge, and positive electrode 14b for charge, are arranged parallel to each other. This metal-air secondary battery 10 is preferably a stationary metal-air secondary battery. The stationary metal-air secondary battery is a stand-alone metal-air secondary battery that is installed after having ensured a predetermined space, and is distinguished from a portable metal-air secondary battery. For convenience of description, the following will be described, assuming that the upper portion of the figure in FIG. 1 is the upper portion of metal-air secondary battery 10. Each component of metal-air secondary battery 10 will be described in turn below.

LDH Separator

Metal-air secondary battery 10 shown in FIG. 1 is one aspect in which a layered double hydroxide (LDH) separator is used as a hydroxide ion conductive separator. The contents described herein for the LDH separator will also apply to a hydroxide ion conductive separator other than the LDH separator, as long as the technical consistency is not lost. Namely, the LDH separator is hereinafter interchangeable with a hydroxide ion conductive separator, as long as the technical consistency is not lost.

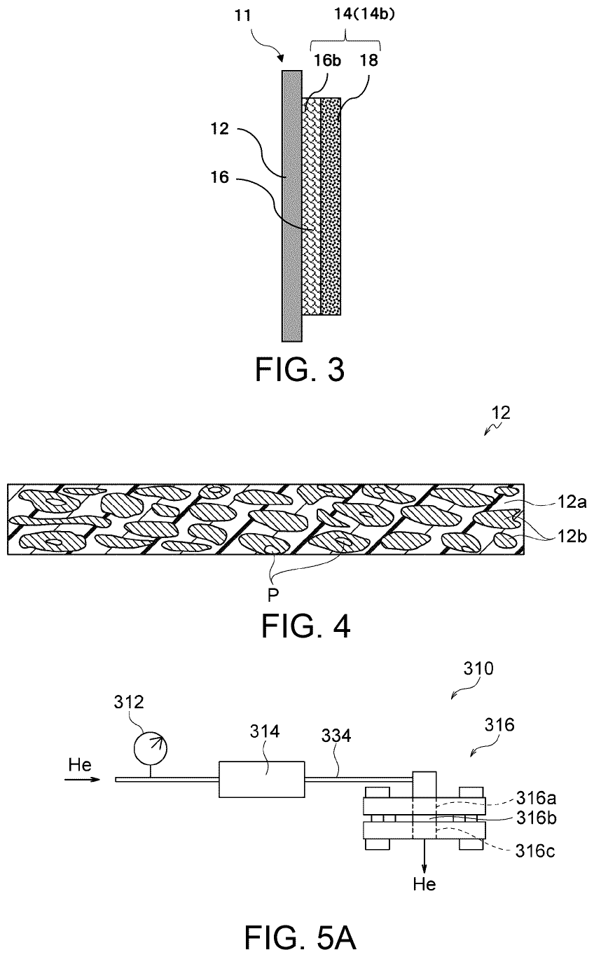

LDH separator 12 is a separator containing a layered double hydroxide (LDH) and/or an LDH-like compound (hereinafter collectively referred to as a hydroxide ion conductive layered compound) and is defined as a separator that selectively passes hydroxide ions by solely utilizing hydroxide ion conductivity of the hydroxide ion conductive layered compound. The “LDH-like compound” herein is a hydroxide and/or oxide having a layered crystal structure analogous to LDH but is a compound that may not be called LDH, and it can be said to be an equivalent of LDH. However, according to a broad sense of definition, it can be appreciated that “LDH” encompasses not only LDH but also LDH-like compounds. Such LDH separators can be those known as disclosed in Patent literatures 1 to 7 and are preferably LDH separators composited with porous substrates. A particularly preferable LDH separator 12 contains a porous substrate 12a made of a polymer material and a hydroxide ion conductive layered compound 12b that clogs up pores P of the porous substrate, as conceptually shown in FIG. 4, and LDH separator 12 of this type will be described later. The porous substrate containing a polymer material can be bent even when pressurized and hardly cracks, and accordingly, battery components including the substrate and other components (negative electrode, etc.) that are housed in a battery container can be pressurized in the direction such that each battery components are adhered to one another. Such pressurization is also advantageous when a plurality of stacked-cell batteries are housed in one module container to constitute a battery module. For example, pressurizing a zinc-air secondary battery minimizes the gap (preferably eliminates the gap) between the negative electrode and LDH separator 12 which gap allows growth of zinc dendrite, whereby effective inhibition of the zinc dendrite propagation can be expected.

However, in the present invention, various hydroxide ion conductive separators can be used instead of LDH separator 12. The hydroxide ion conductive separator is a separator containing the hydroxide ion conductive material and is defined as a separator that selectively passes hydroxide ions by solely utilizing the hydroxide ion conductivity of the hydroxide ion conductive material. Therefore, the hydroxide ion conductive separator has gas impermeability and/or water impermeability, particularly gas impermeability. Namely, the hydroxide ion conductive material constitutes all or a part of the hydroxide ion conductive separator having high denseness such that it exhibits gas impermeability and/or water impermeability. Definitions of gas impermeability and/or water impermeability will be described later with respect to LDH separator 12. The hydroxide ion conductive separator may be composited with a porous substrate.

Metal Negative Electrode

Metal negative electrode 26 contains an active material (negative electrode active material), and causes an oxidation reaction of the active material upon discharge and a reduction reaction upon charge. The negative electrode active materials that are metals such as zinc, lithium, sodium, calcium, magnesium, aluminum, and iron are used, and may partially contain metal oxides thereof.

Negative electrode layer 22 has a configuration in which metal negative electrode 26 is housed in an inner space of LDH separator 12 together with nonwoven fabric 24 for holding an electrolyte, covering metal negative electrode 26, or the like, and an extra space can be provided in the upper portion to account for gas generation such as H₂ gas generated in the course of charge/discharge reactions. Metal negative electrode 26, nonwoven fabric 24, and the like are inserted into the inner space of a pair of LDH separators 12, the three outer edges of which are thermally fused together (except for the top edge) by opening the top edge so as to form a baggy shape followed by injection of an electrolyte, and then the upper open end of negative electrode layer 22 is sealed by thermal fusion. In negative electrode layer 22, metal negative electrode 26 is also housed in the inner space of LDH separator 12, with a lead part of metal negative electrode 26 extending from the upper portion of negative electrode layer 22.

Positive Electrode for Discharge

Positive electrode 14a for discharge has a catalyst having oxygen reduction ability, causing a discharging reaction in which water, an oxygen gas supplied from the atmosphere, and electrons react to produce hydroxide ions (OH⁻). This positive electrode 14a for discharge is required to be provided in such a way that an oxygen gas contained in the atmosphere can diffuse therethrough. For example, positive electrode 14a for discharge is preferably an electrode in which it has a configuration such that at least a surface of positive electrode 14a for discharge is exposed to the atmosphere, and the current collector is a material that is porous and electron conductive.

The positive electrode current collector for discharge is not particularly limited as long as it is composed of an electron conductive material having gas diffusibility, but it is preferably composed of at least one material selected from the group consisting of carbon, nickel, stainless steel, and titanium, and more preferably carbon. Specific examples of porous current collector include carbon paper, nickel foam, nonwoven fabrics made of stainless steel, and arbitrary combinations thereof, and more preferably the carbon paper. A commercially available porous material can be used as the current collector. In view of securing a wide reaction zone, i.e., a wide three-phase interface composed of an ion conductive phase (LDH), an electron conduction phase (porous current collector), and a gas phase (air), the thickness of the porous current collector is preferably 0.1 to 1 mm, more preferably 0.1 to 0.5 mm, and still more preferably 0.1 to 0.3 mm. A porosity of catalyst layer 16a for discharge is also preferably 70% or more and more preferably 70 to 95%. Particularly in the case of carbon paper, it is still more preferably 70 to 90% and particularly preferably 75 to 85%. The porosity values described above enable securing both excellent gas diffusibility and a wide reaction region. Moreover, the generated water is less likely to clog up pores due to the large pore spaces. The porosity can be measured by a mercury intrusion method.

Positive electrode 14a for discharge desirably contains an electron conductive porous material having gas diffusibility, a catalyst for discharge, and a binder. This allows a three-phase interface where oxygen gas, water, and electrons are co-present on the catalyst to be formed, enabling proceeding of a discharge reaction. A catalyst that is a catalyst having oxygen reduction ability is desired, and examples of such catalysts include (i) nickel, (ii) platinum group elements such as palladium and platinum, (iii) perovskite oxides containing transition metals such as cobalt, manganese, and iron, (iv) noble metal oxides such as ruthenium and palladium, (v) manganese oxide, and (vi) arbitrary combinations thereof. The catalyst is desirably a fine particle in order for increasing a reaction field. Specifically, a particle size of the catalyst is preferably 5 μm or less, more preferably 0.5 nm to 3 μm, and still more preferably 1 nm to 3 μm.

The hydroxide ion conductive material contained in catalyst layer 16 has a spherical, platy, or beltlike form and forms a conductive path in the entire catalyst layer. The hydroxide ion conductive material is not particularly limited as long as it has hydroxide ion conductivity and is preferably an LDH. The composition of LDH is not particularly limited, and preferably has a basic composition represented by the formula: M²⁺₁₋ₓM³⁺ₓ(OH)₂Aⁿ⁻_{x/n}·mH₂O, wherein M²⁺ is at least one divalent cation, M³⁺ is at least one trivalent cation, Aⁿ⁻ is an n-valent anion, n is an integer of 1 or more, x is 0.1 to 0.4, and m is an arbitrary real number. In the above formula, M²⁺ can be an arbitrary divalent cation, and preferred examples thereof include Ni²⁺, Mg²⁺, Ca²⁺, Mn²⁺, Fe²⁺, Co²⁺, Cu²⁺, and Zn²⁺. M³⁺ can be an arbitrary trivalent cation, and preferred examples thereof include Fe³⁺, Al³⁺, Co³⁺, Cr³⁺, and In³⁺. In particular, in order for LDH to have both catalytic performance and hydroxide ion conductivity, M²⁺ and M³⁺ each are desirably a transition metal ions. From this viewpoint, more preferred M²⁺ is a divalent transition metal ion such as Ni²⁺, Mn²⁺, Fe²⁺, Co²⁺, and Cu²⁺, and particularly preferably Ni²⁺, and more preferred M³⁺ is a trivalent transition metal ion such as Fe³⁺, Co³⁺, and Cr³⁺, and particularly preferably Fe³⁺. In this case, some of M²⁺ may be replaced with a metal ion other than the transition metal, such as Mg²⁺, Ca²⁺, and Zn²⁺, and some of M³⁺ may be replaced with a metal ion other than the transition metal, such as Al³⁺ and In³⁺. Aⁿ⁻ can be an arbitrary anion. Preferred examples thereof include NO³⁻, CO₃²⁻, SO₄²⁻, OH⁻, Cl⁻, I⁻, Br⁻, and F⁻, and it is more preferably NO³⁻ and/or CO₃²⁻. Therefore, in the above formula, it is preferred that M²⁺ include Ni²⁺, M³⁺ include Fe³⁺, and Aⁿ⁻ include NO³⁻ and/or CO₃²⁻. n is an integer of 1 or more, and preferably 1 to 3. x is 0.1 to 0.4 and preferably 0.2 to 0.35. m is an arbitrary real number and more specifically greater than or equal to 0, typically a real number or an integer greater than 0 or greater than or equal to 1.

The content of the hydroxide ion conductive material contained in catalyst layer 16 is preferably the amount that allows an ion conductive path to be formed within catalyst layer 16. Specifically, the content is preferably 10 to 60% by volume, more preferably 20 to 50% by volume, and still more preferably 20 to 40% by volume, relative to 100% by volume of solid content of catalyst layer 16. The electron conductive material contained in catalyst layer 16 is, on the other hand, preferably at least one selected from the group consisting of electron conductive ceramics and carbon-based materials. Preferred examples of the electron conductive ceramics include LaNiO₃, LaSr₃Fe₃O₁₀, and the like. Examples of the carbon-based materials include carbon black, graphite, carbon nanotubes, graphene, reduced graphene oxide, Ketjen black and arbitrary combinations thereof.

A known binder resin can be used as the binder contained in catalyst layer 16. Examples of the organic polymer include a butyral-based resin, vinyl alcohol-based resin, celluloses, vinyl acetal-based resin, polytetrafluoroethylene, polyvinylidene fluoride, and the like, and the butyral-based resin, polytetrafluoroethylene, and polyvinylidene fluoride are preferable.

Positive Electrode for Charge

Positive electrode 14b for charge has a catalyst having oxygen generation ability, which causes a reaction in which oxygen, water, and electrons are generated from hydroxide ions (OH⁻) supplied via LDH separator 12. In this positive electrode 14b for charge, a charging reaction proceeds at a three-phase interface where oxygen gas, water, and electron conductors are co-present. Therefore, positive electrode 14b for charge is preferably an electrode in which it has a configuration such that an oxygen gas produced by the proceeding of the charging reaction can diffuse, and the current collector is a material that is porous and electron conductive.

As is the case with the positive electrode current collector for discharge, the positive electrode current collector for charge is also not particularly limited as long as it is composed of an electron conductive material having gas diffusibility, but it is preferably composed of at least one material selected from the group consisting of carbon, nickel, stainless steel, and titanium, and more preferably carbon. Specific examples of porous current collector include carbon paper, nickel foam, stainless nonwoven fabric, and any combination thereof, and carbon paper is preferred. A commercially available porous material can be used as the current collector. In view of securing a wide reaction region, i.e., a wide three-phase interface composed of the ion conduction phase (LDH), the electron conduction phase (porous current collector), and the gas phase (air), the thickness of porous current collector is preferably 0.1 to 1 mm, more preferably 0.1 to 0.5 mm, and still more preferably 0.1 to 0.3 mm. The porosity of catalyst layer 16b for charge is also preferably 70% or more and more preferably 70 to 95%. Particularly, in the case of carbon paper, it is still more preferably 70 to 90% and particularly preferably 75 to 85%. The porosity values described above enable securing both excellent gas diffusibility and a wide reaction region. Moreover, the generated water is less likely to clog up pores due to the large pore spaces. The porosity can be measured by a mercury intrusion method.

The hydroxide ion conductive material contained in positive electrode 14b for charge is not particularly limited as long as the material has a hydroxide ion conductivity, and it is preferably LDH and/or a LDH-like compound. The composition of LDH is not particularly limited, and preferably has a basic composition represented by the formula: M²⁺₁₋ₓM³⁺ₓ(OH)₂Aⁿ⁻_{x/n}·mH₂O, wherein M²⁺ is at least one divalent cation, M³⁺ is at least one trivalent cation, Aⁿ⁻ is an n-valent anion, n is an integer of 1 or more, x is 0.1 to 0.4, and m is an arbitrary real number. In the above formula, M²⁺ can be an arbitrary divalent cation, and preferred examples thereof include Ni²⁺, Mg²⁺, Ca²⁺, Mn²⁺, Fe²⁺, Co²⁺, Cu²⁺, and Zn²⁺. M³⁺ can be an arbitrary trivalent cation, and preferred examples thereof include Fe³⁺, Al³⁺, Co³⁺, Cr³⁺, and In³⁺. In particular, in order for LDH to have both catalytic performance and hydroxide ion conductivity, M²⁺ and M³⁺ each are desirably a transition metal ion. From this viewpoint, more preferred M²⁺ is a divalent transition metal ion such as Ni²⁺, Mn²⁺, Fe²⁺, Co²⁺, and Cu²⁺, and particularly preferably Ni²⁺, and more preferred M³⁺ is a trivalent transition metal ion such as Fe³⁺, Co³⁺, and Cr³⁺, and particularly preferably Fe³⁺. In this case, some of M²⁺ may be replaced with a metal ion other than the transition metal, such as Mg²⁺, Ca²⁺, and Zn²⁺, and some of M³⁺ may be replaced with a metal ion other than the transition metal, such as Al³⁺ and In³⁺. Aⁿ⁻ can be an arbitrary anion. Preferred examples thereof include NO³⁻, CO₃²⁻, SO₄²⁻, OH⁻, Cl⁻, I⁻, Br⁻, and F⁻, and it is more preferably NO³⁻ and/or CO₃²⁻. Therefore, in the above formula, it is preferred that M²⁺ include Ni²⁺, M³⁺ include Fe³⁺, and Aⁿ⁻ include NO³⁻ and/or CO₃²⁻. n is an integer of 1 or more, and preferably 1 to 3. x is 0.1 to 0.4 and preferably 0.2 to 0.35. m is an arbitrary real number and more specifically greater than or equal to 0, typically a real number or an integer greater than 0 or greater than or equal to 1.

The air electrode catalyst contained in positive electrode 14b for charge is preferably at least one selected from the group consisting of LDH and other metal hydroxides, metal oxides, metal nanoparticles, and carbon-based materials, and more preferably at least one selected from the group consisting of LDH, metal oxides, metal nanoparticles, and carbon-based materials. LDH is as described above for the hydroxide ion conductive material, which is particularly preferable in terms of performing both the functions of the air electrode catalyst and the hydroxide ion conductive material. Examples of the metal hydroxide include Ni—Fe—OH, Ni—Co—OH and any combination thereof, which may further contain a third metal element. Examples of the metal oxide include Co₃O₄, LaNiO₃, LaSr₃Fe₃O₁₀, and any combination thereof. Examples of the metal nanoparticle (typically metal particle having a particle diameter of 2 to 30 nm) include Pt, Ni—Fe alloy. Examples of the carbon-based material include carbon black, graphite, carbon nanotubes, graphene, reduced graphene oxide, and any combinations thereof, as described above. Preferably, the carbon-based material further contains a metal element and/or other elements such as nitrogen, boron, phosphorus, and sulfur, in view of improving the catalytic performance of the carbon-based material.

A known binder resin can be used as the organic polymer contained in positive electrode 14b for charge. Examples of the organic polymer include a butyral-based resin, vinyl alcohol-based resin, celluloses, vinyl acetal-based resin, and the butyral-based resin is preferable.

Positive electrode 14b for charge and catalyst layer 16b for charge constituting the electrode are desired to have a lower porosity in order to efficiently transfer hydroxide ions to and from LDH separator 12. Specifically, catalyst layer 16b for charge preferably has a porosity of 30 to 60%, more preferably 35 to 60%, and still more 40 to 55%. For the same reason, the average pore diameter of catalyst layer 16b for charge is preferably 5 μm or less, more preferably 0.5 to 4 μm, and still more preferably 1 to 3 μm. The measurements of the porosity and the average pore diameter of catalyst layer 16b for charge can be carried out by a) polishing the cross section of the LDH separator with a cross section polisher (CP), b) using an SEM (scanning electron microscope) at a magnification of 10,000× to acquire images of two fields of vision of the cross-section of catalyst layer 16b for charge, c) binarizing each image by using an image analysis software (for example, Image-J) based on the image data of the acquired cross-sectional image, and d) determining the area of each pore for two fields of vision, calculating the porosity values and the pore diameter values of pores, and taking the average value thereof as the porosity and the average pore diameter of catalyst layer 16b for charge. The pore diameter can be calculated by converting the length per pixel of the image from the actual size, dividing the area of each pore obtained from the image analysis by pi, on the assumption that each pore is a perfect circle, and multiplying the square root of the quotient by 2 to obtain the average pore diameter. The porosity can be calculated by dividing the number of pixels corresponding to pores by the number of pixels in the total area and multiplying the quotient by 100.

Positive electrode 14b for charge can be fabricated by preparing a paste containing the hydroxide ion conductive material, the electron conductive material, the organic polymer, and the air electrode catalyst, and coating the surface of LDH separator with the paste. Preparation of the paste can be carried out by appropriately adding the organic polymer (binder resin) and an organic solvent to a mixture of the hydroxide ion conductive material, the electron conductive material, and the air electrode catalyst, and using a known kneader such as a three-roll mill. Preferred examples of the organic solvent include alcohols such as butyl carbitol and terpineol, acetic acid ester-based solvents such as butyl acetate. Coating LDH separator 12 with the paste can be carried out by printing. This printing can be carried out by various known printing methods, but a screen printing is preferred.

Water Absorption/Desorption Layer

Water absorption/desorption layer 20 is desirably provided in the lower portion of battery case 30 so that it is in contact with positive electrode 14a for discharge and positive electrode 14b for charge, which interpose negative electrode layer 22. The water absorption and desorption action of water absorption/desorption layer 20 makes it possible to absorb water produced by a charging reaction at positive electrode 14b for charge and also to supply water necessary for a discharging reaction, produced at positive electrode 14a for discharge. Thus, the water absorption and desorption action of water absorption/desorption layer 20 can keep positive electrode 14b for charge and positive electrode 14a for discharge in a moisturized condition without them having been dried out, thereby enabling circulation of moisture generated or consumed between positive electrode 14b for charge and positive electrode 14a for discharge, resulting in acceleration of charge/discharge reactions.

Water absorption/desorption layer 20 is not particularly limited as long as it has a space capable of absorbing and desorbing moisture, and is preferably in fibrous or beltlike form. Water absorption/desorption layer 20 also preferably contains a water absorbent material having water absorbability in order to retain moisture. Examples of water absorbent materials include water absorbent resins such as an acrylamide-based polymer, polyvinyl alcohol-based polymer, and polyethylene oxide-based polymer, superabsorbent and desorbent fibers such as cellulose-based fibers, acrylate-based fibers, and arbitrary combinations thereof.

In order to reversely diffuse moisture that is diffused from water absorption/desorption layer 20 toward an outside direction of battery case 30, to water absorption/desorption layer 20, water repellent layer 28 is preferably provided between positive electrode 14b for charge and positive electrode 14a for discharge, and battery case 30.

Water repellent layer 28 refers to a layer that mainly repels water but does not substantially absorb water and allows only gas permeation in and out of battery case 30, and may be of arbitrary configuration as long as it assists circulation of water in water absorption/desorption layer 20, positive electrode 14b for charge, and positive electrode 14a for discharge. For example, carbon paper or carbon cloth having a porosity of approximately 80% can be used.

Namely, as described above, metal-air secondary battery 10 including LDH separator 12 has an excellent advantage of being capable of preventing both the short circuit between the positive and negative electrodes due to the metal dendrite and the inclusion of carbon dioxide. Moreover, it also has an advantage of inhibiting evaporation of water contained in the electrolyte due to the denseness of LDH separator 12. However, since LDH separator 12 blocks the permeation of the electrolyte into air electrode layer 14, the electrolyte is absent in air electrode layer 14 and therefore, circulation of moisture consumed or generated in the air electrode tends to be low, compared with a zinc-air secondary battery including a general separator (for example, a porous polymer separator) that allows permeation of an electrolyte into air electrode layer 14, leading to a decrease in charge/discharge performance. In this respect, water absorption/desorption layer 20 conveniently eliminates such problems. The details of the mechanism are not necessarily clear, but it is surmised as follows. First, since positive electrode 14b for charge contains the porous current collector, it can function as a layer for current collection and gas diffusion as gas diffusion electrode 18, and supporting an LDH on the surface of porous current collector allows the layer to have both catalytic performance and hydroxide ion conductivity in addition to the above functions, resulting in that a larger reaction region can be secured. This is because the LDH, i.e., the layered double hydroxide, is a hydroxide ion conductive material and can have oxygen generation catalytic ability as well. In this case, the moisture generated by a charging reaction that occurs at positive electrode 14b for charge is appropriately absorbed by water absorption/desorption layer 20, which is in contact with positive electrode 14b for charge at the lower portion. Since positive electrode 14a for discharge also contains the porous current collector as is the case with positive electrode 14b for charge, it can function as a layer for current collection and gas diffusion as gas diffusion electrode 18, and further supporting an oxygen reduction catalyst on the surface of the porous current collector allows the layer to secure a larger reaction region. In this case, the moisture consumed in positive electrode 14a for discharge is appropriately supplied by capillary action from water absorption/desorption layer 20, which is in contact with positive electrode 14a for discharge at the lower portion. It is surmised that by conveniently combining the various functions of positive electrode 14a for discharge, positive electrode 14b for charge, and water absorption/desorption layer 20 in such a way, excellent charge/discharge performance can be realized while having the advantage of using LDH separator 12.

LDH Separator According to Preferred Aspect

LDH separator 12 according to a preferred embodiment of the present invention will be described below. Although the following description assumes a zinc-air secondary battery, LDH separator 12 according to the present embodiment can also be applied to other metal-air secondary batteries such as a lithium-air secondary battery. As described above, LDH separator 12 of the present embodiment contains a porous substrate 12a and a hydroxide ion conductive layered compound 12b which is the LDH and/or LDH-like compound, as conceptually shown in FIG. 4. In FIG. 4, the region of hydroxide ion conductive layered compound 12b is drawn so as not to be connected between the upper surface and the lower surface of LDH separator 12, but it is because the figure is drawn two-dimensionally as a cross section. When the depth thereof is three-dimensionally taken into account, the region of hydroxide ion conductive layered compound 12b is connected between the upper surface and the lower surface of LDH separator 12, whereby the hydroxide ion conductivity of LDH separator 12 is secured. Porous substrate 12a is made of a polymer material, and the pores of porous substrate 12a are clogged up with hydroxide ion conductive layered compound 12b. However, the pores of porous substrate 12a may not be completely clogged up, and residual pores P can be slightly present. By clogging up the pores of polymer porous substrate 12a with hydroxide ion conductive layered compound 12b to make the substrate highly densified in this way, LDH separator 12 capable of even more effectively inhibiting short circuits due to zinc dendrites can be provided.

Moreover, LDH separator 12 of the present embodiment has excellent flexibility and strength in addition to desirable ion conductivity required of a separator due to the hydroxide ion conductivity of hydroxide ion conductive layered compound 12b. This is due to the flexibility and strength of polymer porous substrate 12a itself contained in LDH separator 12. Namely, since LDH separator 12 is densified so that the pores of polymer porous substrate 12a are sufficiently clogged up with hydroxide ion conductive layered compound 12b, polymer porous substrate 12a and hydroxide ion conductive layered compound 12b are integrated in complete harmony as a highly composited material, and therefore the rigidity and brittleness due to hydroxide ion conductive layered compound 12b, which is a ceramic material, can be said to be offset or reduced by the flexibility and strength of polymer porous substrate 12a.

LDH separator 12 of the present embodiment desirably has extremely few residual pores P (the pores not clogged up with hydroxide ion conductive layered compound 12b). Due to residual pores P, LDH separator 12 has, for example, an average porosity of 0.03% or more and less than 1.0%, preferably 0.05% or more and 0.95% or less, more preferably 0.05% or more and 0.9% or less, still more preferably 0.05 to 0.8%, and most preferably 0.05 to 0.5%. With an average porosity within the above range, the pores of porous substrate 12a are sufficiently clogged up with hydroxide ion conductive layered compound 12b to provide an extremely high denseness, which therefore can inhibit short circuits due to zinc dendrites even more effectively. Further, significantly high ionic conductivity can be realized, and LDH separator 12 can exhibit a sufficient function as a hydroxide ion conductive separator. The measurement of the average porosity can be carried out by a) polishing the cross section of the LDH separator with a cross section polisher (CP), and b) using an FE-SEM (field-emission scanning electron microscope) at a magnification of 50,000× to acquire images of two fields of vision of the cross-sectional of the functional layer, and c) calculating the porosity of each of the two fields of vision by using an image inspection software (for example, HDevelop, manufactured by MVTec Software GmbH) based on the image data of the acquired cross-sectional image and determining the average value of the obtained porosities.

LDH separator 12 is a separator containing hydroxide ion conductive layered compound 12b, and separates a positive electrode plate and a negative electrode plate such that hydroxide ions can be conducted when the separator is incorporated in a zinc secondary battery. Namely LDH separator 12 exhibits a function as a hydroxide ion conductive separator. Therefore, LDH separator 12 has gas impermeability and/or water impermeability. Thus, LDH separator 12 is preferably densified so as to have gas impermeability and/or water impermeability. As described in Patent Literatures 2 and 3, “having gas impermeability” herein means that even when helium gas is brought into contact with one side of the object to be measured in water at a differential pressure of 0.5 atm, no bubbles are generated due to the helium gas from another surface side. Further, as used herein, “having water impermeability” means that water in contact with one side of the object to be measured does not permeate to the other side as described in Patent Literatures 2 and 3. Namely, LDH separator 12 having gas impermeability and/or water impermeability means LDH separator 12 having a high degree of denseness such that it does not allow gas or water to pass through, and means that LDH separator 12 is not a porous film or other porous material that has water permeability or gas permeability. In this way, LDH separator 12 selectively allows hydroxide ions alone to pass through due to its hydroxide ion conductivity and can exhibit a function as a battery separator. Therefore, the configuration is extremely effective in physically blocking penetration of the separator by the zinc dendrite generated upon charge to prevent a short circuit between the positive and negative electrodes. Since LDH separator 12 has hydroxide ion conductivity, it is possible to efficiently move the required hydroxide ions between the positive electrode plate and the negative electrode plate, and to realize the charge/discharge reaction in the positive electrode plate and the negative electrode plate.

LDH separator 12 preferably has a He permeability of 3.0 cm/min-atm or less per unit area, more preferably 2.0 cm/min-atm or less, and still more preferably 1.0 cm/min-atm or less. A separator having a He permeability of 3.0 cm/min-atm or less can extremely effectively inhibit Zn permeation (typically permeation of zinc ion or zinc acid ion) in an electrolyte. It is considered in principle that due to such significant inhibition of Zn penetration, the separator of the present embodiment can inhibit effectively the growth of zinc dendrite when used in a zinc secondary battery. The He permeability is measured by supplying He gas to one surface of the separator to allow the He gas to pass through the separator, and calculating the He permeability to evaluate the denseness of the hydroxide ion conductive separator. The He permeability is calculated by the formula of F/(P×S) by using the permeation amount F of the He gas per unit time, the differential pressure P applied to the separator when the He gas permeates, and the membrane area S through which the He gas permeates. By evaluating the gas permeability using the He gas in this way, it is possible to evaluate the presence or absence of denseness at an extremely high level, and as a result, it is possible to effectively evaluate a high degree of denseness such that substances other than hydroxide ions (in particular Zn bringing about zinc dendrite growth) can be permeated as little as possible (only a very small amount is permeated). This is because an He gas has the smallest constituent unit among a wide variety of atoms or molecules that can form a gas and also has extremely low reactivity. Namely, He constitutes a He gas by a single He atom without forming a molecule. In this respect, hydrogen gas is composed of H₂ molecules, and the He atom alone is smaller as a gas constituent unit. In the first place, H₂ gas is dangerous because it is a flammable gas. Then, by adopting the index of He gas permeability defined by the above formula, it is possible to easily evaluate the denseness objectively regardless of the difference in various sample sizes and measurement conditions. In this way, it is possible to easily, safely and effectively evaluate whether or not the separator has sufficiently high denseness suitable for a zinc secondary battery separator. The measurement of He permeability can be preferably carried out according to the procedure in Evaluation 4 of the Example described later.

In LDH separator 12, hydroxide ion conductive layered compound 12b, which is an LDH and/or LDH-like compound, clogs up the pores of porous substrate 12a. As is generally known, LDH is composed of a plurality of hydroxide basic layers and an intermediate layer interposed between the plurality of hydroxide basic layers. The basic hydroxide layer is mainly composed of metal elements (typically metal ions) and OH groups. The intermediate layer of LDH is composed of anions and H₂O. The anion is a mono- or higher-valent anion and preferably a monovalent or divalent ion. The anion in LDH preferably contains OH⁻ and/or CO₃²⁻. LDH also has excellent ion conductivity due to its unique properties.

In general, LDH has been known as a compound represented by the basic composition formula: M²⁺₁₋ₓM³⁺ₓ(OH)₂Aⁿ⁻_{x/n}·mH₂O wherein M²⁺ is a divalent cation, M³⁺ is a trivalent cation, Aⁿ⁻ is an n-valent anion, n is an integer of 1 or more, x is 0.1 to 0.4, and m is 0 or more. In the above basic composition formula, M²⁺ can be arbitrary divalent cation, but preferred examples thereof include Mg²⁺, Ca²⁺ and Zn²⁺, and it is more preferably Mg²⁺. M³⁺ can be arbitrary trivalent cation, a preferred example thereof includes Al³⁺ or Cr³⁺, and it is more preferably Al³⁺. Aⁿ⁻ can be arbitrary anion, and preferred examples thereof include OH⁻ and CO₃²⁻. Therefore, in the above basic composition formula, it is preferred that M²⁺ include Mg²⁺, M³⁺ include Al³⁺, and Aⁿ⁻ include OH⁻ and/or CO₃²⁻. n is an integer of 1 or more, and is preferably 1 or 2. x is 0.1 to 0.4 and preferably 0.2 to 0.35. m is an arbitrary numeral meaning the number of moles of water, is greater than or equal to 0, typically a real number greater than 0 or greater than or equal to 1. However, the above basic composition formula is merely a representatively exemplified formula of the “basic composition” of LDH, generally, and the constituent ions can be appropriately replaced. For example, in the above basic composition formula, some or all of M³⁺ may be replaced with a tetra- or higher-valent cation, and in that case, the coefficient x/n of anion Aⁿ⁻ in the above formula may be appropriately changed. For example, the hydroxide basic layer of LDH may contain Ni, Al, Ti and OH groups. The intermediate layer is composed of anions and H₂O as described above. The alternating laminated structure of the hydroxide basic layer and the intermediate layer, itself is basically the same as the generally known LDH alternating laminated structure, but the LDH of the present embodiment in which the hydroxide basic layer of LDH is composed of predetermined elements or ions including Ni, Al, Ti and OH groups can exhibit excellent alkali resistance. The reason for this is not necessarily clear, but it is considered that Al, which has been conventionally thought to be easy to elute in an alkaline solution, is less likely to elute in an alkaline solution due to some interaction with Ni and Ti in the LDH of the present embodiment. Nevertheless, LDH of the present embodiment can also exhibit high ion conductivity suitable for use as a separator for an alkaline secondary battery. Ni in LDH can be in the form of nickel ions. Nickel ions in LDH are typically considered to be Ni 2+ but are not particularly limited thereto as other valences such as Ni 3+ are possible. Al in LDH can be in the form of aluminum ions. Aluminum ions in LDH are typically considered to be Al³⁺ but are not particularly limited thereto as other valences are possible. Ti in LDH can be in the form of titanium ions. Titanium ions in LDH are typically considered to be Ti⁴⁺ but are not particularly limited thereto as other valences such as Ti³⁺ are possible. The hydroxide basic layer may contain other elements or ions as long as it contains at least Ni, Al, Ti and OH groups. However, the hydroxide basic layer preferably contains Ni, Al, Ti and OH groups as main components. Namely, the hydroxide basic layer is preferably mainly composed of Ni, Al, Ti and OH groups. Therefore, the hydroxide basic layer is typically composed of Ni, Al, Ti, OH groups and, in some cases, unavoidable impurities. The unavoidable impurity is an arbitrary element that can be unavoidably mixed due to the production process, and can be mixed in LDH, for example, derived from a raw material or a substrate. As described above, the valences of Ni, Al and Ti are not always fixed, and it is impractical or impossible to specify LDH strictly by a general formula. Assuming that the hydroxide basic layer is mainly composed of Ni²⁺, Al³⁺, Ti⁴⁺ and OH groups, the corresponding LDH has the basic composition that can be represented by the formula: Ni²⁺_{1-x-y}Al³⁺ₓTi⁴⁺_{y}(OH)₂Aⁿ⁻_{(x+2y)/n}·mH₂O wherein Aⁿ⁻ is an n-valent anion, n is an integer of 1 or more and preferably 1 or 2, 0<x<1 and preferably 0.01≤x≤0.5, 0<y<1 and preferably 0.01≤y≤0.5, 0<x+y<1, m is 0 or more and typically a real number greater than 0 or greater than or equal to 1. However, the above formula is understood as “basic composition”, and it is understood that elements such as Ni 2+, Al³⁺, and Ti⁴⁺ are replaceable with other elements or ions (including the same elements or ions having other valences, or elements or ions unavoidably mixed due to the production process) to an extent such that the basic characteristics of LDH are not impaired.

LDH-like compound is a hydroxide and/or oxide having a layered crystal structure like to LDH but is a compound that may not be called LDH. Preferred LDH-like compounds will be discussed below. By using an LDH-like compound that is a hydroxide and/or oxide having a layered crystal structure with the predetermined composition described below, instead of the conventional LDH, as the hydroxide ion conductive substance, a hydroxide ion conductive separator can be provided that is excellent in the alkali resistance and capable of inhibiting a short circuit due to zinc dendrite even more effectively.

As described above, LDH separator 12 contains hydroxide ion conductive layered compound 12b and porous substrate 12a (typically LDH separator 12 is composed of porous substrate 12a and hydroxide ion conductive layered compound 12b), and the hydroxide ion conductive layered compound clogs up pores of the porous substrate so that LDH separator 12 exhibits hydroxide ion conductivity and gas impermeability (hence to function as an LDH separator exhibiting hydroxide ion conductivity). Hydroxide ion conductive layered compound 12b is particularly preferably incorporated over the entire area of polymer porous substrate 12a in the thickness direction. The thickness of the LDH separator is preferably 3 to 80 μm, more preferably 3 to 60 μm, and still more preferably 3 to 40 μm.

Porous substrate 12a is made of a polymer material. Polymer porous substrate 12a has advantages of 1) having flexibility (hence, polymer porous substrate 12a hardly cracks even when it is thin.), 2) facilitating increase in porosity, and 3) facilitating increase in conductivity (it can be thin while having increased porosity.), and 4) facilitating manufacture and handling. Further, taking advantage derived from the flexibility of 1) above, it also has an advantage of 5) ease in bending or sealing/bonding the LDH separator containing a porous substrate made of a polymer material. Preferred examples of the polymer material include polystyrene, polyether sulfone, polypropylene, an epoxy resin, polyphenylene sulfide, a fluororesin (tetrafluororesin: PTFE, etc.), cellulose, nylon, polyethylene and any combination thereof. In view of a thermoplastic resin suitable for heat pressing, more preferred examples include polystyrene, polyether sulfone, polypropylene, an epoxy resin, polyphenylene sulfide, a fluororesin (tetrafluororesin: PTFE, etc.), nylon, polyethylene and any combination thereof. All of the various preferred materials described above have the alkali resistance, which serves as a resistance to the electrolyte of the battery. Particularly preferable polymer materials are polyolefins such as polypropylene and polyethylene and most preferably polypropylene or polyethylene in terms of excellent hot water resistance, acid resistance and alkali resistance as well low cost. When the porous substrate is made of a polymer material, the hydroxide ion conductive layered compound is particularly preferably incorporated over the entire porous substrate in the thickness direction (for example, most or almost all of the pores inside the porous substrate are filled with the hydroxide ion conductive layered compound.). As such a polymer porous substrate, a commercially available polymer microporous membrane can be preferably used.

The LDH separator of the present embodiment can be produced by (i) fabricating the hydroxide ion conductive layered compound-containing composite material according to a known method (see, for example, Patent Literatures 1 to 3) by using a polymer porous substrate, and (ii) pressing this hydroxide ion conductive layered compound-containing composite material. The pressing method may be, for example, a roll press, a uniaxial pressure press, a CIP (cold isotropic pressure press), etc., and is not particularly limited. The pressing method is preferably by a roll press. This pressing is preferably carried out while heating in terms of softening the porous substrate to enable to clog up sufficiently the pores of the porous substrate with the hydroxide ion conductive layered compound. For example, for polypropylene or polyethylene, the temperature for sufficient softening is preferably heated at 60 to 200° C. Pressing by, for example, a roll press in such a temperature range can significantly reduce the average porosity derived from the residual pores of the LDH separator; as a result, the LDH separator can be extremely highly densified, and hence short circuits due to zinc dendrites can be inhibited even more effectively. When carrying out the roll pressing, the form of the residual pores can be controlled by appropriately adjusting the roll gap and the roll temperature, whereby an LDH separator having a desired denseness or average porosity can be obtained.

The method for producing the hydroxide ion conductive layered compound-containing composite material (i.e., the crude LDH separator) before pressing is not particularly limited, and it can be fabricated by appropriately changing the conditions in a known method for producing an LDH-containing functional layer and a composite material (i.e., LDH separator) (see, for example, Patent Literatures 1 to 3). For example, the hydroxide ion conductive layered compound-containing functional layer and the composite material (i.e., an LDH separator) can be produced by (1) providing a porous substrate, (2) coating the porous substrate with a titanium oxide sol or a mixed sol of alumina and titania followed by heat treatment to form a titanium oxide layer or alumina/titania layer, (3) immersing the porous substrate in a raw material aqueous solution containing nickel ions (Ni²⁺) and urea, and (4) treating hydrothermally the porous substrate in the raw material aqueous solution to form a hydroxide ion conductive layered compound-containing functional layer on the porous substrate and/or in the porous substrate. In particular, forming of the titanium oxide layer or the alumina/titania layer on the porous substrate in the above step (2) provides not only the raw material of the hydroxide ion conductive layered compound, but also the function as a starting point of the crystal growth of the hydroxide ion conductive layered compound to enable to form uniformly a highly densified hydroxide ion conductive layered compound-containing functional layer in the porous substrate. Further, the urea present in the above step (3) generates ammonia in the solution by utilizing the hydrolysis of the urea to raise the pH value, which allows the coexisting metal ions to form a hydroxide to obtain a hydroxide ion conductive layered compound. In addition, since the hydrolysis involves the generation of carbon dioxide, a hydroxide ion conductive layered compound having an anion of carbonate ion type can be obtained. In particular, when fabricating a composite material including a porous substrate made of a polymer material in which the functional layer is incorporated over the entire porous substrate in the thickness direction (i.e., an LDH separator), the substrate is preferably coated with the mixed sol of alumina and titania in the above (2) so as to permeate the whole or most of the inside of the substrate with the mixed sol. In this way, most or almost all the pores inside the porous substrate can be finally filled with the hydroxide ion conductive layered compound. Examples of a preferable coating method include a dip coating and a filtration coating, and a dip coating is particularly preferable. By adjusting the number of times of coating by the dip coating, etc., the amount of the mixed sol adhered can be adjusted. The substrate coated with the mixed sol by dip coating, etc. may be dried and then the above steps (3) and (4) may be carried out.

LDH-Like Compounds

According to a preferred aspect of the present invention, the LDH separator can be a separator that contains an LDH-like compound. The definition of the LDH-like compound is as described above. Preferred LDH-like compounds are as follows,
(a) a hydroxide and/or oxide having a layered crystal structure containing Mg and one or more elements selected from the group consisting of Ti, Y, and Al, and containing at least Ti; or
(b) a hydroxide and/or oxide having a layered crystal structure containing (i) Ti, Y, optionally Al and/or Mg, and (ii) at least one additive element M selected from the group consisting of In, Bi, Ca, Sr and Ba, or
(c) a hydroxide and/or oxide having a layered crystal structure containing Mg, Ti, Y, optionally Al and/or In, wherein in (c), the LDH-like compound is present in a form of mixture with In(OH)₃.

According to the preferred aspect (a) of the present invention, the LDH-like compound can be a hydroxide and/or oxide having a layered crystal structure containing Mg and one or more elements selected from the group consisting of Ti, Y and Al and containing at least Ti. Thus, a typical LDH-like compound is a complex hydroxide and/or complex oxide of Mg, Ti, optionally Y and optionally Al. The above elements may be replaced with other elements or ions to an extent that the basic characteristics of the LDH-like compound are not impaired, but the LDH-like compound preferably contains no Ni. For example, the LHD-like compound may be a compound further containing Zn and/or K. In such a manner, ionic conductivity of the LDH separator can be further improved.

LDH-like compounds can be identified by X-ray diffraction. Specifically, when X-ray diffraction is carried out on the surface of the LDH separator, a peak assigned to the LDH-like compound is detected typically in the range of 5°≤2θ≤0°, and more typically in the range of 7°≤2θ≤W 0°. As described above, the LDH is a substance having an alternating laminated structure in which exchangeable anions and H₂O are present as an intermediate layer between the stacked hydroxide basic layers. In this regard, when LDH is analyzed by the X-ray diffraction method, a peak assigned to the crystal structure of LDH (i.e., the peak assigned to (003) of LDH) is originally detected at a position of 2θ=11 to 12°. When the LDH-like compound is analyzed by the X-ray diffraction method, on the other hand, a peak is typically detected in the aforementioned range shifted to the lower angle side than the above peak position of LDH. Further, the interlayer distance of the layered crystal structure can be determined by Bragg's equation using 28 corresponding to the peak assigned to the LDH-like compound in X-ray diffraction. The interlayer distance of the layered crystal structure of the LDH-like compound thus determined is typically 0.883 to 1.8 nm, and more typically 0.883 to 1.3 nm.

The LDH separator by the aforementioned aspect (a) has an atomic ratio of Mg/(Mg+Ti+Y+Al) in the LDH-like compound, as determined by energy dispersive X-ray spectroscopy (EDS), which is preferably 0.03 to 0.25 and more preferably 0.05 to 0.2. Moreover, the atomic ratio of Ti/(Mg+Ti+Y+Al) in the LDH-like compound is preferably 0.40 to 0.97 and more preferably 0.47 to 0.94. Further, the atomic ratio of Y/(Mg+Ti+Y+Al) in the LDH-like compound is preferably 0 to 0.45 and more preferably 0 to 0.37. Further, the atomic ratio of Al/(Mg+Ti+Y+Al) in the LDH-like compound is preferably 0 to 0.05 and more preferably 0 to 0.03. Within the above ranges, the alkali resistance is more excellent, and the effect of inhibiting a short circuit due to zinc dendrite (i.e., dendrite resistance) can be more effectively realized. By the way, LDH conventionally known for LDH separators has the basic composition that can be represented by the formula: M²⁺₁₋ₓM³⁺ₓ(OH)₂Aⁿ⁻_{x/n}·mH₂O, wherein M²⁺ is a divalent cation, M³⁺ is a trivalent cation, Aⁿ⁻ is an n-valent anion, n is an integer of 1 or more, x is 0.1 to 0.4, and m is 0 or more. The atomic ratios in the LDH-like compound generally deviate from those in the above formula for LDH. Therefore, the LDH-like compound in the present aspect generally can be said to have a composition ratio (atomic ratio) different from that of the conventional LDH. EDS analysis is preferably carried out with an EDS analyzer (for example, X-act, manufactured by Oxford Instruments Plc.), by 1) capturing an image at an acceleration voltage of 20 kV and a magnification of 5,000×, 2) carrying out three-point analysis at intervals of about 5 μm in the point analysis mode, 3) repeating the above 1) and 2) once more, and 4) calculating the average value of a total of 6 points.

According to another preferred aspect (b) of the present invention, the LDH-like compound can be a hydroxide and/or oxide having a layered crystal structure containing (i) Ti, Y, and optionally Al and/or Mg and (ii) additive element M. Therefore, a typical LDH-like compound is a complex hydroxide and/or complex oxide of Ti, Y, additive element M, optionally Al and optionally Mg. Additive element M is In, Bi, Ca, Sr, Ba or combinations thereof. The above elements may be replaced with other elements or ions to an extent such that the basic characteristics of the LDH-like compound are not impaired, but the LDH-like compound preferably contains no Ni.

The LDH separator by the aforementioned aspect (b) has an atomic ratio of Ti/(Mg+Al+Ti+Y+M) in the LDH-like compound, as determined by energy dispersive X-ray spectroscopy (EDS), which is preferably 0.50 to 0.85 and more preferably 0.56 to 0.81. The atomic ratio of Y/(Mg+Al+Ti+Y+M) in the LDH-like compound is preferably 0.03 to 0.20 and more preferably 0.07 to 0.15. The atomic ratio of M/(Mg+Al+Ti+Y+M) in the LDH-like compound is preferably 0.03 to 0.35 and more preferably 0.03 to 0.32. The atomic ratio of Mg/(Mg+Al+Ti+Y+M) in the LDH-like compound is preferably 0 to and more preferably 0 to 0.02. Then, the atomic ratio of Al/(Mg+Al+Ti+Y+M) in the LDH-like compound is preferably 0 to 0.05 and more preferably 0 to 0.04. Within the above ranges, the alkali resistance is more excellent, and the effect of inhibiting a short circuit due to zinc dendrite (i.e., dendrite resistance) can be more effectively realized. By the way, LDH conventionally known for LDH separators has the basic composition that can be represented by the formula: M²⁺₁₋ₓM³⁺ₓ(OH)₂Aⁿ⁻_{x/n}·mH₂O, wherein M₂₊ is a divalent cation, M³⁺ is a trivalent cation, Aⁿ⁻ is an n-valent anion, n is an integer of 1 or more, x is 0.1 to 0.4, and m is 0 or more. The atomic ratios in the LDH-like compound generally deviate from those in the above formula for LDH. Therefore, the LDH-like compound in the present aspect generally can be said to have a composition ratio (atomic ratio) different from that of the conventional LDH. EDS analysis is preferably carried out with an EDS analyzer (for example, X-act, manufactured by Oxford Instruments Plc.), by 1) capturing an image at an acceleration voltage of 20 kV and a magnification of 5,000×, 2) carrying out three-point analysis at intervals of about 5 μm in the point analysis mode, 3) repeating the above 1) and 2) once more, and 4) calculating the average value of a total of 6 points.

According to another further preferred aspect (c) of the present invention, the LDH-like compound can be a hydroxide and/or oxide having a layered crystal structure containing Mg, Ti, Y, and optionally Al and/or In, wherein the LDH-like compound is present in a form of mixture with In(OH)₃. The LDH-like compound in this aspect is a hydroxide and/or oxide having a layered crystal structure containing Mg, Ti, Y, and optionally Al and/or In. Therefore, a typical LDH-like compound is a complex hydroxide and/or complex oxide of Mg, Ti, Y, optionally Al and optionally In. The In that can be contained in the LDH-like compound may be not only In intentionally added to the LDH-like compound but also that unavoidably mixed into the LDH-like compound, due to formation of In(OH)₃ or the like. The above elements can be replaced with other elements or ions to an extent that the basic characteristics of the LDH-like compound are not impaired, however, the LDH-like compound preferably contains no Ni. By the way, LDH conventionally known for LDH separators has the basic composition that can be represented by the formula: M²⁺₁₋ₓM³⁺ₓ(OH)₂Aⁿ⁻_{x/n}·mH₂O, wherein M²⁺ is a divalent cation, M³⁺ is a trivalent cation, Aⁿ⁻ is an n-valent anion, n is an integer of 1 or more, x is 0.1 to 0.4, and m is 0 or more. The atomic ratios in the LDH-like compound generally deviate from those in the above formula for LDH. Therefore, the LDH-like compound in the present aspect generally can be said to have a composition ratio (atomic ratio) different from that of the conventional LDH.

The mixture by the above aspect (c) contains not only the LDH-like compound but also In(OH)₃ (typically composed of the LDH-like compound and In(OH)₃). In(OH)₃ contained can effectively improve alkali resistance and dendrite resistance in LDH separators. The content proportion of In(OH)₃ in the mixture is preferably the amount that can improve alkali resistance and dendrite resistance with little impairment of hydroxide ion conductivity of the LDH separator, and is not particularly limited. In(OH)₃ may have a cubic crystal structure, and have a configuration in which the crystals of In(OH)₃ are surrounded by LDH-like compounds. In(OH)₃ can be identified by X-ray diffraction.

### EXAMPLES

The present invention will be described in more detail by the following examples.

### Example A1

LDH separators were fabricated by the following procedure and evaluated.

(1) Provision of Polymer Porous Substrate

A commercially available polyethylene microporous membrane having a porosity of 50%, an average pore diameter of 0.1 μm and a thickness of 20 μm was provided as a polymer porous substrate, and cut out to a size of 2.0 cm×2.0 cm.

(2) Alumina-Titania Sol Coating on Polymer Porous Substrate

Amorphous alumina solution (Al-ML15, manufactured by Taki Chemical Co., Ltd.) and titanium oxide sol solution (M⁶, manufactured by Taki Chemical Co., Ltd.) were mixed in Ti/Al (molar ratio)=2 to fabricate a mixed sol. The substrate provided in (1) above was coated with the mixed sol by dip coating. The dip coating was carried out by immersing the substrate in 100 ml of the mixed sol, pulling it up vertically, and drying it in a dryer at 90° C. for 5 minutes.

(3) Preparation of Raw Material Aqueous Solution

Nickel nitrate hexahydrate (Ni(NO₃)₂·6H₂O, manufactured by Kanto Chemical Co., Inc., and urea ((NH₂)₂CO, manufactured by Sigma Aldrich Co. LLC)) were provided as raw materials. Nickel nitrate hexahydrate was weighed so as to give 0.015 mol/L and placed in a beaker, and ion-exchanged water was added thereto to make a total volume 75 ml. After stirring the obtained solution, urea weighed to satisfy the ratio of urea/NO₃⁻ (molar ratio)=16 was added in the solution, and the mixture was further stirred to obtain a raw material aqueous solution.

(4) Film Formation by Hydrothermal Treatment

The raw material aqueous solution and the dip-coated substrate were placed together in a Teflon® airtight container (autoclave container with outer stainless-steel jacket, content of 100 ml), and the container was closed tightly. At this time, the substrate was fixed while being floated from the bottom of the Teflon® airtight container and placed horizontally so that the solution was in contact with both sides of the substrate. Then, LDH was formed on the surface and the inside of the substrate by subjecting it to hydrothermal treatment at a hydrothermal temperature of 120° C. for 24 hours. With an elapse of a predetermined time, the substrate was taken out from the airtight container, washed with ion-exchanged water, and dried at 70° C. for 10 hours to form LDH in the pores of the porous substrate. In this way, a composite material containing LDH was obtained.

(5) Densification by Roll Pressing

The composite material containing LDH described above was sandwiched between a pair of PET films (Lumirror®, thickness of 40 μm, manufactured by Toray Industries, Inc.) and the roll pressing was carried out at a roll rotation speed of 3 mm/s, a roll temperature of 120° C., and a roll gap of 60 μm to obtain an LDH separator.

(6) Evaluation Result

The following evaluation was carried out for the obtained LDH separator.

Evaluation 1: Identification of LDH Separator

An XRD profile was obtained by measuring the crystal phase of the LDH separator with an X-ray diffractometer (RINT TTR III manufactured by Rigaku Corporation) under the measurement conditions of voltage: 50 kV, current value: 300 mA, and measurement range: 10 to 70°. For the obtained XRD profile, identification was carried out by using the diffraction peak of LDH (hydrotalcites compound) described in JCPDS card No. 35-0964. The LDH separator of the present example was identified as LDH (hydrotalcites compound).

Evaluation 2: Measurement of Thickness

The thickness of the LDH separator was measured using a micrometer. The thicknesses were measured at three points, and the average value thereof was taken as the thickness of the LDH separator. As a result, the thickness of the LDH separator of the present example was 13 μm.

Evaluation 3: Measurement of Average Porosity

The LDH separator was cross-sectionally polished with a cross-section polisher (CP), and two fields of vision of the LDH separator cross-sectional image were acquired with a FE-SEM (ULTRA55, manufactured by Carl Zeiss) at a magnification of 50,000×. Based on this image data, porosity of each of the two fields of vision was calculated by using an image inspection software (HDevelop, manufactured by MVTec Software GmbH) and the average value thereof was taken as the average porosity of the LDH separator. As a result, the average porosity of the LDH separator of the present example was 0.8%.

Evaluation 4: Measurement of he Permeation

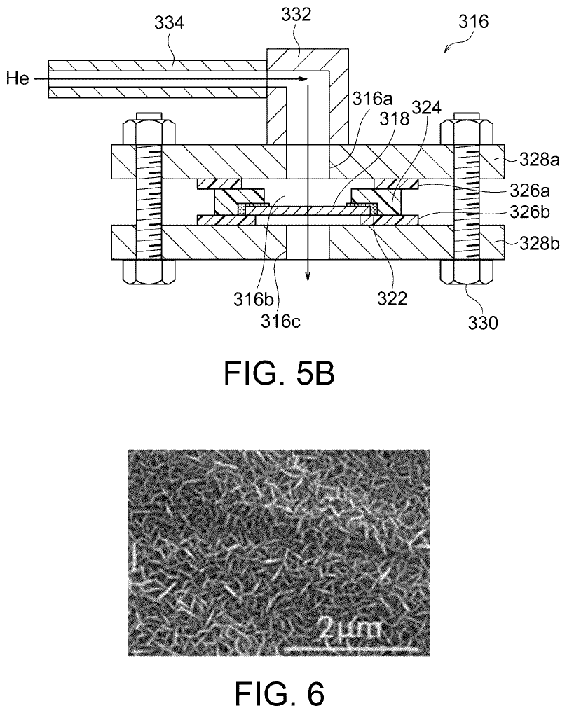

The He permeation test was carried out as follows in order to evaluate the denseness of the LDH separator in terms of He permeability. First, a He permeability measurement system 310 shown in FIGS. 5A and 5B was constructed. He permeability measurement system 310 was configured so that He gas from a gas cylinder filled with He gas was supplied to a sample holder 316 via a pressure gauge 312 and a flow meter 314 (digital flow meter) and was allowed to pass from one surface of LDH separator 318 held in sample holder 316 to the other surface to be discharged.

Sample holder 316 has a structure comprising a gas supply port 316a, a closed space 316b, and a gas discharge port 316c, and was assembled as follows. First, the outer circumference of LDH separator 318 was coated with an adhesive 322 and was attached to a jig 324 (made of ABS resin) having an opening in the center. Packings made of butyl rubber were arranged as sealing members 326a and 326b at the upper and lower ends of this jig 324 and were further sandwiched with support members 328a and 328b (made of PTFE) with openings, which were flanges, from the outside of sealing members 326a and 326b. In this way, closed space 316b was defined by LDH separator 318, jig 324, sealing member 326a, and support member 328a. Support members 328a and 328b were fastened tightly to each other by a fastening means 330 using screws so that He gas did not leak from a portion other than a gas discharge port 316c. A gas supply pipe 334 was connected to gas supply port 316a of sample holder 316 thus assembled via a joint 332.

Next, He gas was supplied to He permeability measurement system 310 through gas supply pipe 334 and was allowed to pass through LDH separator 318 held in sample holder 316. At this time, the gas supply pressure and the flow rate were monitored by pressure gauge 312 and flow meter 314. After the passage of the He gas for 1 to 30 minutes, the He permeability was calculated. The He permeability was calculated by using the formula: F/(P×S), wherein F (cm³/min) is the amount of the He gas passing per unit time, P (atm) is the differential pressure applied to the LDH separator when the He gas passes, and S (cm 2) is the membrane area through which the He gas passes. The amount F (cm³/min) of He gas passing was read directly from flow meter 314. Further, differential pressure P was determined by using the gauge pressure read from pressure gauge 312. The He gas was supplied so that differential pressure P was in the range of 0.05 to 0.90 atm. As a result, the He permeability per unit area of the LDH separator was 0.0 cm/min-atm.

Evaluation 5: Observation of Microstructure of Separator Surface

When observing the surface of the LDH separator by SEM, it was observed that innumerable LDH platy particles were bonded vertically or obliquely to the main surface of the LDH separator, as shown in FIG. 6.

### Example B1

A zinc-air secondary battery comprising an air electrode/separator assembly was fabricated by using the LDH separator fabricated in Example A1 by the following procedure, and was evaluated.
(1) Fabrication of positive electrode catalyst for charge

(1a) Iron Oxide Sol Coating on Conductive Porous Substrate

10 ml of iron oxide sol (Fe-C10, iron oxide concentration of 10% by weight, manufactured by Taki Chemical Co., Ltd.) diluted with ion-exchanged water and adjusted to a concentration of 5% by weight was placed in a beaker, and carbon paper (TGP-H-060, thickness of 200 μm, manufactured by Toray Industries, Inc.) was immersed therein. The beaker was evacuated to allow the iron oxide sol to fully penetrate into the carbon paper. The carbon paper was pulled up from the beaker by using tweezers and dried at 80° C. for 30 minutes to obtain a carbon paper to which iron oxide particles were adhered as a substrate.

(1b) Preparation of Raw Material Aqueous Solution

Nickel nitrate hexahydrate (Ni(NO₃)₂·6H₂O, manufactured by Kanto Chemical Co., Inc., and urea ((NH₂)₂CO, manufactured by Mitsui Chemicals Inc.)) were provided as raw materials. Nickel nitrate hexahydrate was weighed so as to give a concentration of mol/L and placed in a beaker, and ion-exchanged water was added thereto to make the total volume 75 ml. After stirring the obtained solution, urea was added to the solution to 0.96 mol/I, and the mixture was further stirred to obtain a raw material aqueous solution.

(1c) Membrane Formation by Hydrothermal Treatment

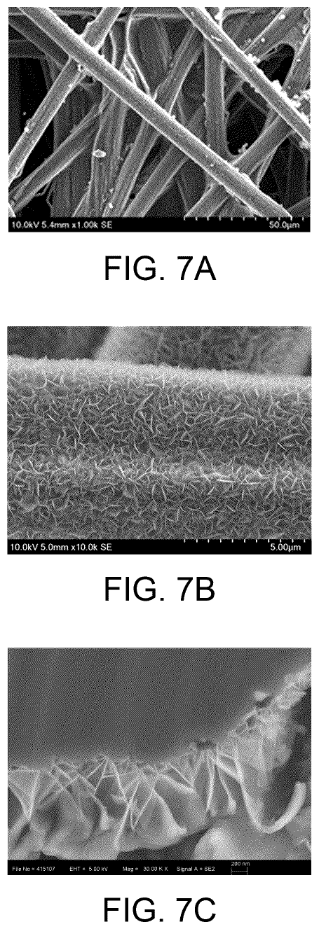

The raw material aqueous solution fabricated in (1b) above and the substrate fabricated in (1a) above were placed together in a Teflon® airtight container (autoclave container with outer stainless-steel jacket, content of 100 ml), and the container was closed tightly. At this time, the substrate was fixed while being floated from the bottom of the Teflon® airtight container and placed horizontally so that the solution was in contact with both sides of the substrate. Then, LDH was formed on the fiber surface inside the substrate by subjecting it to hydrothermal treatment at a hydrothermal temperature of 120° C. for hours. With an elapse of a predetermined time, the substrate was taken out from the airtight container, washed with ion-exchanged water, and dried at 80° C. for 30 minutes to obtain a catalyst layer as the air electrode layer. When the fine structure of the obtained catalyst layer was observed by SEM, the images shown in FIGS. 7A to 7C were obtained. FIG. 7B is an enlarged image of the surface of the carbon fibers constituting the carbon paper shown in FIG. 7A, and FIG. 7C is an enlarged cross-sectional image of the vicinity of the surface of the carbon fibers shown in FIG. 7A. From these figures, it was observed that innumerable LDH platy particles were vertically or obliquely bonded to the surface of the carbon fibers constituting the carbon paper, and that these LDH platy particles were connected to one another.

The porosity of the obtained positive electrode for charge was measured by the mercury intrusion method and found to be 76%.

(2) Joining of Positive Electrode for Charge and LDH Separator

5% by weight of carbon powder (Denka Black, manufactured by Denka Co., Ltd.) was added to ethanol (purity 99.5%, manufactured by Kanto Chemical Co., Inc.) and the mixture was dispersed by ultrasonic waves to prepare a carbon slurry. The LDH separator obtained in Example A1 was coated with the obtained slurry by spin coating, and then the positive electrode for charge was placed. A weight was placed on the positive electrode for charge and dried in the air at 80° C. for 2 hours. In this way, the positive electrode for charge (thickness 200 μm) was formed on the LDH separator. At this time, an interface layer (thickness of 0.2 μm) containing LDH platy particles (derived from the LDH separator) and carbon (derived from the carbon slurry) was simultaneously formed between the LDH separator and the positive electrode for charge. Namely, a positive electrode for charge/separator assembly was obtained.

(3) Joining of Positive Electrode for Discharge and LDH Separator

To 25 parts by weight of carbon powder (TOKABLACK #3855, manufactured by Tokai Carbon Co., Ltd.), 23 parts by weight of LDH powder (Ni—Fe-LDH powder fabricated by a coprecipitation method) and 8 parts by weight of platinum supported carbon (EC-20-PTC, manufactured by Toyo Corporation), 5 parts by weight of a butyral resin, and 39 parts by weight of butyl carbitol were added, and the mixture was kneaded with three rolls and a planetary centrifugal mixer (ARE-310, manufactured by THINKY CORPORATION) to obtain paste. A surface of the LDH separator fabricated in Example A1 was coated with this paste by screen printing to fabricate a positive electrode catalyst layer for discharge. Before the fabricated paste dried, a gas diffusion electrode (SIGRACET29BC) and subsequently a weight were placed on the paste to dry at 80° C. for 30 minutes in air to obtain a positive electrode for discharge/separator assembly.

(4) Fabrication of Water Absorption/Desorption Layer

A polyvinyl alcohol (160-11485 manufactured by FUJIFILM Wako Pure Chemical Corporation) was dissolved in ion-exchanged water to make a 10% by weight aqueous solution and was impregnated into a nonwoven fabric (FT-7040P, manufactured by JAPAN VILENE COMPANY, LTD.). The impregnated nonwoven fabric was sandwiched between a pair of plates so as to be 1.5 mm thickness and then dried. The nonwoven fabric was removed from the plates and again immersed in ion-exchanged water for 1 hour, and then cut to a size (5 mm width) which was adjusted to a circumference of the electrode, with the fabric having still been absorbed water, to fabricate a water absorption/desorption layer.

(5) Fabrication of Zinc Oxide Negative Electrode

To 100 parts by weight of ZnO powder (manufactured by Seido Chemical Industry Co., Ltd., JIS Standard Class 1 grade, average particle size D50: 0.2 μm) were added 5 parts by weight of metallic Zn powder (manufactured by Mitsui Mining & Smelting Co., Ltd., Bi and In doped, Bi: 1000 ppm by weight, In: 1000 ppm by weight, average particle size D50: 100 μm) and further added 1.26 parts by weight of a polytetrafluoroethylene (PTFE) dispersion aqueous solution (manufactured by Daikin Industries, Ltd., solid content: 60%) in terms of solid content, and the mixture was kneaded together with propylene glycol. The resulting kneaded product was rolled by a roll press to obtain a 0.4 mm negative electrode active material sheet. The negative electrode active material sheet was then pressed onto a copper expanded metal treated with tin and then dried in a vacuum dryer at 80° C. for 14 hours. The negative electrode sheet after drying was cut out so that a portion coated with the active material has 2 cm squares, and a Cu foil was welded to the current collector portion to obtain a zinc oxide negative electrode.

(6) Thickness Measurement of Catalyst Layer

Before forming a catalyst layer, thicknesses of the LDH separator and gas diffusion electrode were measured at three locations, respectively by using a micrometer, and each average value of these thicknesses was adopted as each thickness. After the air electrode/separator assembly was fabricated, thicknesses of the air electrode/separator assembly were measured at three locations, and the thickness obtained by subtracting the thicknesses of the LDH separator and gas diffusion electrode from the average value at three locations, was adopted as a thickness of the catalyst layer. As a result, the thickness of the catalyst layer in the present example was 15 μm.

(7) Water Absorption Test of Water Absorption/Desorption Layer

As in (4) above, a dried body of the fabricated water absorption/desorption layer was cut into 1.5 cm squares, weighed, and then immersed in ion-exchanged water for 1 hour. After 1 hour, the water absorption/desorption layer was removed, placed on a KimWipe for 15 seconds for draining, and then weighed. The amount of water absorption was calculated by using the following formula, resulting in 20 g/g.

(Weight of water absorption/desorption layer after water absorption [g]−Weight of water absorption/desorption layer before water absorption [g])/(Weight of water absorption/desorption layer before water absorption [g])

(8) Assembly and Evaluation of Evaluation Cells

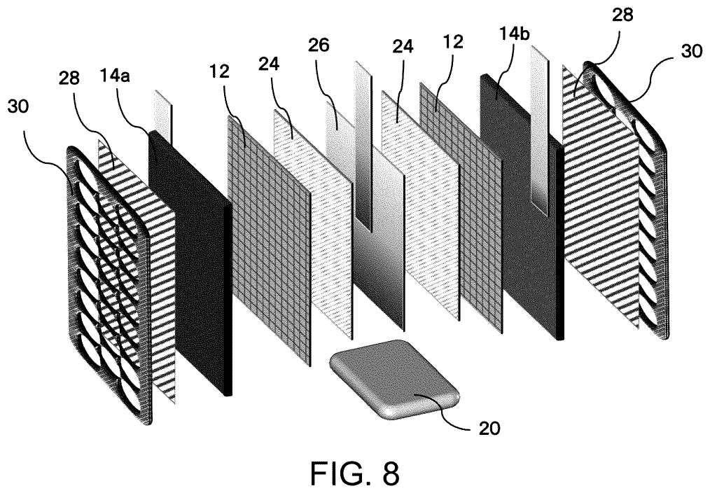

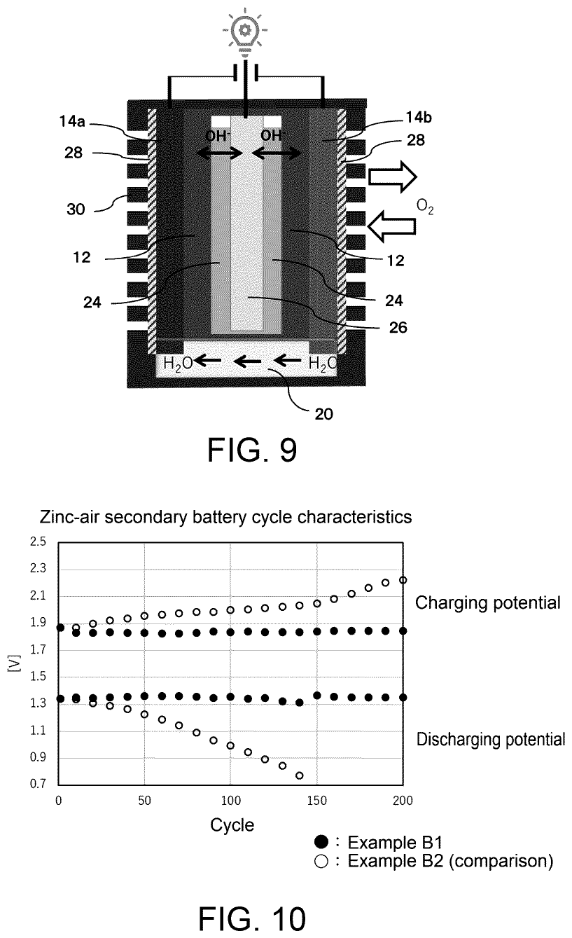

As shown in FIG. 8, the assembly of positive electrode 14a for discharge/separator 12 and the assembly of positive electrode 14b for charge/separator 12 were arranged so that LDH separators 12 faced each other, and nonwoven fabric 24 impregnated with an electrolyte and the metallic zinc plate (negative electrode 26) were sandwiched therebetween. In this case, a 5.4 M KOH aqueous solution saturated with zinc oxide was used as the electrolyte. The edges of the four circumferential sides of the resulting laminate underwent thermocompression bonding, and water absorption/desorption layer 20 was sandwiched between each lower side of the laminate. Water repellent layer 28 and a substrate with gas channels (equivalent to battery case 30) were laminated on both surfaces of the obtained assembly (the surface of the positive electrode for discharge and the surface of the positive electrode for charge), and the obtained laminate was sandwiched between the holding jigs with a sealing member firmly bitten on the outer circumferential portion, and the resultant was firmly fixed with screws to obtain an evaluation cell having a configuration as shown FIG. 9.

Using an electrochemical measuring device (HZ-Pro S12 manufactured by Hokuto Denko Corporation), the charge/discharge characteristics of the evaluation cell were determined under the following conditions:
Air electrode gas: Water vapor saturation (25° C.) oxygen (flow rate of 200 cc/min)
Charge/discharge current density: 2 mA/cm 2
Charge/discharge time: 60 minutes charge/60 minutes discharge
Number of cycles: 200 cycles.

The results are as shown in FIG. 10. Although the evaluation cell (zinc-air secondary battery) fabricated in the present example has a configuration in which no electrolyte is present in the air electrode layer (therefore it is inherently prone to higher resistance), it is found from FIG. 10 that the charge/discharge overvoltage was inhibited from increasing even after elapsed cycles.

### Example B2 (Comparison)

An evaluation cell was fabricated in the same manner as in Example B1, except that no water absorption/desorption layer was provided in the evaluation cell, and evaluation thereof was conducted. The results are as shown in FIG. 10. Since the evaluation cell fabricated in the examples did not contain the water absorption/desorption layer, it was found from FIG. 10 that the charge/discharge overvoltage largely increased after elapsed cycles.

What is claimed is:

1. An air electrode/separator assembly, comprising:
a hydroxide ion conductive separator comprising an inner space capable of housing a metal negative electrode, or a metal negative electrode and an electrolyte-containing nonwoven fabric,
a pair of catalyst layers covering both surfaces of the hydroxide ion conductive separator and comprising a catalyst for an air electrode, a hydroxide ion conductive material, and an electron conductive material,
a pair of gas diffusion electrodes provided on the pair of catalyst layers on a side opposite to the hydroxide ion conductive separator, and
a water absorption/desorption layer provided so as to contact both of the pair of catalyst layers, having water absorbability and desorbability,
wherein one of the pair of catalyst layers is a catalyst layer for discharge and the other of the pair of catalyst layers is a catalyst layer for charge, and
wherein the hydroxide ion conductive separator, the catalyst layer, and the gas diffusion electrode are arranged vertically and the water absorption/desorption layer is positioned below the catalyst layer.

2. The air electrode/separator assembly according to claim 1, wherein the water absorption/desorption layer comprises a water absorbent resin.

3. The air electrode/separator assembly according to claim 2, wherein the water absorption/desorption layer further comprises silica gel.

4. The air electrode/separator assembly according to claim 2, wherein the water absorbent resin is at least one selected from the group consisting of a polyacrylamide-based resin, potassium polyacrylate, a polyvinyl alcohol-based resin, and a cellulose-based resin.

5. The air electrode/separator assembly according to claim 2, wherein the catalyst layer comprises 0.01 to 10% by volume of the water absorbent resin in terms of solid content relative to 100% by volume of solid content of the catalyst layer.

6. The air electrode/separator assembly according to claim 1, wherein the hydroxide ion conductive material included in the catalyst layer is a layered double hydroxide (LDH).

7. The air electrode/separator assembly according to claim 1, wherein the catalyst layer comprises 20 to 50% by volume of the hydroxide ion conductive material relative to 100% by volume of solid content of the catalyst layer.

8. The air electrode/separator assembly according to claim 1, wherein the hydroxide ion conductive separator is a layered double hydroxide (LDH) separator.

9. The air electrode/separator assembly according to claim 8, wherein the LDH separator is composited with a porous substrate.

10. The air electrode/separator assembly according to claim 1, wherein the hydroxide ion conductive separator comprising the inner space comprises a pair of hydroxide ion conductive separators facing each other or a folded hydroxide ion conductive separator, and the pair of hydroxide ion conductive separators or the folded hydroxide ion conductive separator may have sides (excluding folded edges) other than the top edges closed with each other by joining.

11. A metal-air secondary battery comprising the air electrode/separator assembly according to claim 1, a metal negative electrode housed in the inner space, and an electrolyte, wherein the water absorption/desorption layer is positioned below the catalyst layer.

12. The metal-air secondary battery according to claim 11, further comprising an electrolyte-containing nonwoven fabric in the inner space.
